(19) United States
(12) Patent Application Publication
(10) Pub. No.: US 2011/0253176 A1
(43) Pub. Date: Oct. 20, 2011

(54) METHOD AND APPARATUS FOR WASHING SUBSTRATE

(76) Inventor: Kazuhide SAITO, Toyama (JP)

(21) Appl. No.: 13/018,714

(22) Filed: Feb. 1, 2011

(30) Foreign Application Priority Data
Apr. 19, 2010 (JP) 2010-096155

(51) Int. Cl. B08B 3/00

(52) U.S. Cl. 134/26; 134/105

(57) ABSTRACT

A substrate washing method for supplying a process liquid onto a substrate to wash the substrate includes the steps of (a) supplying a first process liquid of a first temperature onto the substrate having a resist pattern, to cover a surface of the substrate with the first process liquid, and (b) supplying a second process liquid onto the surface of the substrate covered with the first process liquid, to cover the surface of the substrate with the second process liquid of a second temperature higher than the first temperature, thereby removing the resist pattern.

### CROSS-REFERENCE TO RELATED APPLICATION

This application claims priority to Japanese Patent Application No. 2010-096155 filed on Apr. 19, 2010, the disclosure of which including the specification, the drawings, and the claims is hereby incorporated by reference in its entirety.

### BACKGROUND

The fabrication of semiconductor devices includes the step of locally implanting an impurity (ion), such as phosphorus, arsenic, boron, etc., into a surface of the semiconductor substrate. In the step, a resist pattern made of a photosensitive resin is formed on the substrate surface in order to mask a region which does not require ion implantation, thereby preventing ions from being implanted into the region. After the ion implantation, the resist pattern is no longer needed and is therefore removed by a resist removal process.

There are two typical resist removal techniques: an ashing process using exposure to oxygen plasma etc.; and a washing process using a sulfuric acid/hydrogen peroxide mixture (SPM) etc. Conventionally, the ashing process has been typically used to remove the ion-implanted resist. In recent years, however, as the design rules of the device have been reduced, the process of removing the resist only by SPM washing without ashing to avoid dose loss due to ashing (an ion-implanted region of the substrate is oxidized, so that the effective dose is reduced), has received increasing attention.

Here, it is known that, when ions are implanted into the resist pattern formed on the substrate, the resist surface is damaged by ion implantation to form an altered layer, which hinders the removal of the resist using the SPM.

The altered layer refers to a layer in which the resist is altered by damage due to ion implantation, more specifically a layer in which a chemical bond (e.g., C—H bond, etc.) in the resist is destroyed (the layer is assumed to be carbonized). In particular, when ions are implanted into the resist surface at a high concentration (dose: 5×10¹⁴/cm² or more) which is a typical condition for ion implantation in a transistor formation step etc., a hard altered layer is formed in the resist surface. In order to quickly remove such an altered layer to a satisfactory extent, the SPM having a high temperature needs to be supplied to the substrate surface.

There are two types of SPM washing: batch processing where multiple substrates (wafers) are simultaneously processed; and single-wafer processing where substrates (wafers) are processed on a one-by-one basis. The conventional mainstream was the batch type. In recent years, however, the single-wafer processing, which can be performed at a high temperature of 140° C., has been widely used.

In the single-wafer SPM washing process, the SPM is supplied from a nozzle to a center of a surface of a substrate while the substrate is rotated at a constant rotational speed. Here, a pipe is coupled to the nozzle, and a mixing valve is provided at a point between the opposite ends of the pipe.

When sulfuric acid and hydrogen peroxide are supplied to the mixing valve, these are mixed to react with each other to generate an SPM containing a component having oxidizing power, such as peroxomonosulfuric acid (Caro's acid) etc. The temperature of the generated SPM is increased by the heat of the reaction of sulfuric acid and hydrogen peroxide while flowing through the pipe. The SPM having the increased temperature is supplied to the substrate surface. The SPM is spread on the substrate surface from the center to the edge by centrifugal force caused by rotation of the substrate, so that the entire substrate surface is quickly covered with the SPM. As a result, the resist formed on the substrate surface is removed by the oxidizing power of the SPM (see, for example, Japanese Patent Publication No. 2005-109167).

### SUMMARY

In the single-wafer washing method, however, when the resist film to which ions have been implanted at a high dose of about 5×10¹⁴/cm² is removed using the SPM having a high temperature of about 140° C., a residue is left in the vicinity of a portion of the substrate surface where the SPM was poured from the nozzle.

The present disclosure describes implementations of a technique of reducing or preventing the occurrence of the residue of a resist pattern etc. on a substrate in a single-wafer washing method and apparatus for removing the resist pattern from the substrate.

As a result of their studies, the present inventor has found that the residue is caused by the altered layer caused by ion implantation being lifted off and thereafter readhering to the substrate (the residue is referred to as a readhering residue). This will be described hereinafter.

When the flow of the SPM supplied onto the substrate contacts the resist pattern, a fragile portion of a surface of the resist pattern (e.g., a thin portion of the altered layer) is dissolved and removed, and from that portion as a starting point, the inside of the resist pattern is dissolved and removed. As a result, the altered layer, for which it takes a longer time to dissolve than the unaltered portion, is lifted off the substrate.

Here, when the temperature of the SPM is high (e.g., about 140° C.), the fragile portion of the resist pattern is instantaneously dissolved, and therefore, the lift-off is also quickly performed. As a result, at a front portion of the flow of the SPM, the altered layer is lifted off, accumulated, and precipitated to readhere to the substrate surface. Thus, a residue occurs on the substrate surface after SPM washing.

In contrast to this, when the temperature of the SPM is relatively low (e.g., about 120° C.), it takes a relatively long time to dissolve the fragile portion of the resist pattern, and therefore, the fluid flow from the center to the edge of the substrate surface becomes stable by the time that the lift-off of the altered layer occurs. In this case, the lifted-off altered layer is removed from the substrate by the fluid flow and therefore does not substantially readhere to the substrate. As a result, substantially no residue is left on the substrate surface after SPM washing.

As described above, the readhesion of the residue is effectively avoided by using the SPM having a low temperature. In the single-wafer SPM washing, however, when the SPM having a low temperature is used, it takes a considerably long time to remove the resist pattern. In other words, the use of the SPM having a high temperature is more preferable in terms of productivity and cost. Although the SPM is illustrated as the process liquid, the present disclosure is not limited to this.

An example substrate washing method of the present disclosure includes the steps of, (a) supplying a first process liquid of a first temperature onto a substrate having a resist pattern, to cover a surface of the substrate with the first process liquid, and (b) supplying a second process liquid onto the surface of the substrate covered with the first process liquid, to cover the surface of the substrate with the second process liquid of a second temperature higher than the first temperature, thereby removing the resist pattern.

Note that, in step (b), the surface temperature of the substrate may reach the second temperature.

In the substrate washing method, in step (a), the substrate surface is covered with the first process liquid of the first temperature with which a residue is less likely to occur, and a stable fluid flow is formed on the substrate. Thereafter, in step (b), the second process liquid is supplied, so that the substrate surface is covered with the second process liquid of the second temperature having a high power of removing the resist pattern. As a result, the altered layer is quickly lifted off, and is removed from the substrate by the stable fluid flow already formed on the substrate surface. Thus, the increase of the process time and the occurrence of the residue can be reduced or prevented.

In step (b), the second process liquid of the higher temperature than that of the first process liquid may be supplied to the surface of the substrate.

Specifically, before being supplied onto the substrate, the temperature of the second process liquid may be adjusted to a higher temperature than the first temperature.

In step (b), by heating the substrate, the temperature of the second process liquid may be increased to the second temperature.

Specifically, after the second process liquid is supplied onto the substrate, the temperature of the second process liquid covering the surface of the substrate may be increased to the second temperature by increasing the temperature of the substrate.

The resist pattern may contain implanted ions.

An altered layer may be formed in a surface of the resist pattern by ion implantation.

The altered layer may be formed by implanting ions into the resist pattern at a dose of 5×10¹⁴/cm² or more.

In such a case, the effect of reducing or preventing the occurrence of a readhering residue is significantly achieved.

The first temperature may be a temperature at which the altered layer is not lifted off.

In this case, the occurrence of a readhering residue in step (a) can be reduced or prevented.

The second process liquid may be a mixture of sulfuric acid and hydrogen peroxide.

The first temperature may be 80° C. or more and 120° C. or less. The second temperature may be 140° C. or more and 200° C. or less. The first and second process liquids are each a mixture of sulfuric acid and hydrogen peroxide.

In this case, in step (a), the substrate surface is covered with the first process liquid while the occurrence of a readhering residue is reduced or avoided, and in step (b), the resist can be quickly removed.

A first example substrate washing apparatus of the present disclosure includes a substrate holder configured to hold a substrate, a chemical liquid mixer configured to mix a first chemical liquid and a second chemical liquid to obtain a third chemical liquid, a pouring nozzle configured to pour the third chemical liquid onto the substrate, a chemical liquid pipe configured to allow the third chemical liquid to flow from the chemical liquid mixer to the pouring nozzle, and a cooling liquid-filled pipe configured to cover the chemical liquid pipe.

The third chemical liquid, when flowing through the chemical liquid pipe, may be cooled by a cooling liquid with which the cooling liquid-filled pipe is filled.

In the substrate washing apparatus, the temperature of the third chemical liquid can be adjusted by utilizing the cooling liquid-filled pipe. Therefore, the substrate washing apparatus can be used in the substrate washing method of the present disclosure.

A second example substrate washing apparatus of the present disclosure includes a substrate holder configured to hold a substrate, a chemical liquid mixer configured to mix a first chemical liquid and a second chemical liquid to obtain a third chemical liquid, a chemical liquid temperature adjuster configured to adjust the temperature of the third chemical liquid, and a pouring nozzle configured to pour the third chemical liquid onto the substrate.

In the substrate washing apparatus, the temperature of the third chemical liquid can be adjusted by the chemical liquid temperature adjuster. Therefore, the substrate washing apparatus can be used in the substrate washing method of the present disclosure.

A third example substrate washing apparatus of the present disclosure includes a substrate holder configured to hold a substrate, a chemical liquid mixer configured to mix a first chemical liquid and a second chemical liquid to obtain a third chemical liquid, a pouring nozzle configured to pour the third chemical liquid onto the substrate, and a substrate temperature adjuster configured to adjust the temperature of the substrate.

In the substrate washing apparatus, by adjusting the temperature of the substrate, the temperature of the chemical liquid supplied onto the substrate can be adjusted. Therefore, the substrate washing apparatus can be used in the substrate washing method of the present disclosure.

The mixing of the first and second chemical liquids may generate heat. For example, the first and second chemical liquids may be sulfuric acid and hydrogen peroxide, respectively.

As described above, according to the substrate washing method and the substrate washing apparatus of the present disclosure, both the increase of the process time required for washing and the occurrence of a residue after washing can be reduced or prevented, resulting in an increase in throughput and yield in manufacture of semiconductor devices.

### BRIEF DESCRIPTION OF THE DRAWINGS

FIGS. 1A-1C are diagrams showing the temperature of an SPM and the occurrence of a residue when a resist pattern is removed using the SPM.

FIG. 2 is a diagram showing the relationship between the temperature of the SPM, the concentration of ion implantation, and the time that it takes to remove a resist.

FIG. 3A is a diagram for describing a first embodiment of the present disclosure, particularly showing a substrate to be washed.

FIG. 3B is a diagram showing a flow of a washing method in the first embodiment.

FIG. 3C is a diagram showing the relationship between the process time and the surface temperature of the substrate in the first embodiment.

FIG. 4 is a diagram showing residue densities obtained in an example substrate washing method of the first embodiment and a comparative example substrate washing method.

FIG. 5 is a diagram schematically showing an example substrate washing apparatus according to a second embodiment of the present disclosure.

FIG. 6 is a diagram schematically showing a washing process chamber in the substrate washing apparatus of FIG. 5.

FIG. 7 is a diagram showing a flow of an example substrate washing method according to the second embodiment.

FIG. 8 is a diagram showing an example substrate washing apparatus according to a third embodiment of the present disclosure.

FIG. 9 is a diagram schematically showing a washing process chamber in the substrate washing apparatus of FIG. 8.

FIG. 10 is a diagram showing a flow of an example substrate washing method according to the third embodiment.

FIG. 11 is a diagram showing an example substrate washing apparatus according to a fourth embodiment of the present disclosure.

FIG. 12 is a diagram schematically showing a washing process chamber in the substrate washing apparatus of FIG. 11.

FIG. 13 is a diagram showing a flow of an example substrate washing method according to the fourth embodiment.

### DETAILED DESCRIPTION

Embodiments of the present disclosure will be described hereinafter with reference to the accompanying drawings. Firstly, the inventor's finding will be described that a residue (readhering residue) of a resist pattern occurs on a substrate when the resist pattern is removed using an SPM because the resist readheres to the substrate after an altered layer caused by ion implantation is lifted off.

The resist pattern on the substrate is removed by SPM washing as follows. An SPM is supplied from a nozzle to a vicinity of a center of a substrate while the substrate is horizontally placed and rotated. When the flow of the SPM contacts the resist pattern, a fragile portion of the resist pattern (e.g., a thin portion of an altered layer which is a portion of a surface of the resist pattern which is altered by ion implantation, etc.) is dissolved and removed. Next, from this portion as a starting point, the SPM infiltrates an inside of the resist pattern (a portion which is not altered by ion implantation), so that the inside of the resist pattern is dissolved and removed. The altered layer is less easily dissolved than the unaltered portion of the resist pattern, and therefore, it takes a relatively long time to dissolve the altered layer completely. As a result, the inside of the resist pattern is dissolved and removed earlier than the altered layer, so that the altered layer is lifted off.

Here, when the temperature of the SPM is high (e.g., about 140° C.), the fragile portion of the resist pattern is instantaneously dissolved, and therefore, the altered layer is lifted off at a front portion of the flow of the SPM (a front portion of the SPM which is spreading on the substrate). Because the altered layer is not instantaneously dissolved, the altered layer is accumulated at the front portion of the flow of the SPM, and then precipitated to readhere to the substrate surface. Thus, a residue of the resist pattern is left on the substrate surface after SPM washing.

In contrast to this, when the temperature of the SPM is relatively low (e.g., about 120° C.), the power of the SPM to dissolve the altered layer is lower than that of the SPM having a high temperature. Therefore, the fragile portion of the resist pattern is not instantaneously dissolved, and it takes a relatively long time to dissolve the fragile portion of the resist pattern, and therefore, it also takes a relatively long time to lift off the altered layer. As a result, the substrate surface will have been completely covered with the SPM and a stable flow of the SPM from the center (pouring position) to the edge of the substrate will have been formed before the lift-off of the altered layer occurs. In this case, the lifted-off altered layer is not precipitated and is removed from the substrate by the fluid flow, and therefore, does not substantially readhere to the substrate. As a result, substantially no residue is left on the substrate surface after SPM washing.

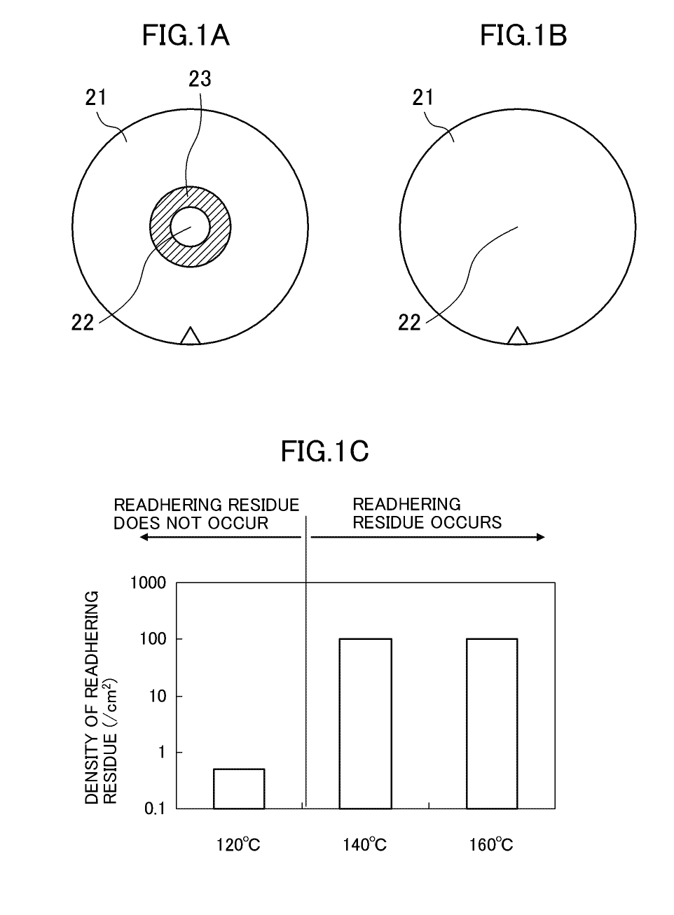

As described above, the residue is significantly left when the SPM has a high temperature of about 140° C. or more. FIGS. 1A and 1B schematically show the results of removal of a resist pattern using the SPM from a semiconductor substrate 21, where the resist pattern contains ions which have been implanted at a dose of about 5×10¹⁴/cm². FIG. 1A shows a case where the SPM having a high temperature of about 140° C. or more is used. In this case, a large amount of residue 23 is left in the vicinity of a position where the SPM is poured from the nozzle (SPM pouring position). Note that FIG. 1A is a schematic illustration of a region where a large amount of the residue is left, as the residue 23, but not an actual residue shape. Also, a residue may be left in the other region. In contrast to this, FIG. 1B shows a case where the SPM having a low temperature of about 120° C. is used. In this case, substantially no residue is left in the vicinity of the SPM pouring position 22 or in the other portion.

FIG. 1C shows the relationship between the temperature of the SPM and the density of a residue of a resist pattern, where the SPM is used to remove the resist pattern containing ions which have been implanted at a dose of about 5×10¹⁴/cm². When the SPM having a liquid temperature of 140° C. or 160° C. is used (processing time: 60 or 30 sec, respectively), the residue is left at a density of about 100/cm². In contrast to this, when the SPM having a liquid temperature of 120° C. is used (process time: 4,200 sec), the residue is left at a density of about 0.5/cm². Thus, by using the low-temperature SPM, the occurrence of the residue can be reduced or prevented.

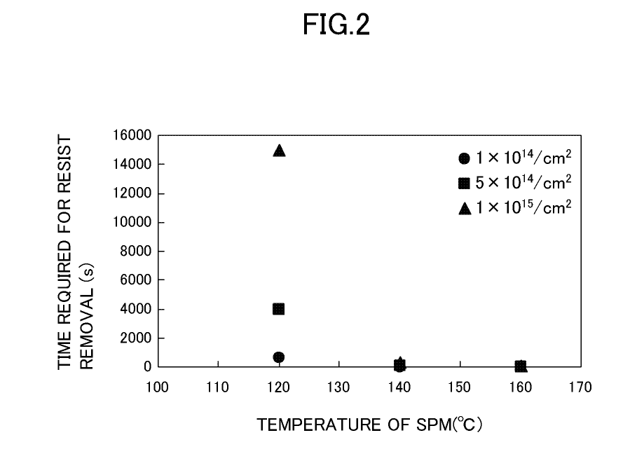

Note that, as described above, when the low-temperature SPM is used, it takes a longer time to remove the resist pattern. In this regard, FIG. 2 shows the relationship between the time that it takes to remove a resist film having a thickness of 0.5 μm, and the temperature of the SPM. More specifically, FIG. 2 shows times that it takes to remove resist films in which ions have been implanted at a dose of about 1×10¹⁴/cm², about 5×10¹⁴/cm², and about 1×10¹⁵/cm², using the SPM having a temperature of 120° C., 140° C., and 160° C.

As can be seen from FIG. 2, when the concentration of implanted ions is low (e.g., about 1×10¹⁴/cm²), the resist film removal power of the SPM does not significantly vary within the range of 120° C. to 160° C. In contrast to this, when the concentration of implanted ions is 5×10¹⁴/cm² or more, the resist film removal power of the SPM significantly varies depending on the temperature of the SPM. Specifically, if the temperature of the SPM is 140° C. or more, it takes about 60 sec to remove the resist film irrespective of the concentration of implanted ions. By contrast, if the temperature of the SPM is 120° C., it takes about 4,000 sec when the concentration of implanted ions is about 5×10¹⁴/cm², and it takes about 15,000 sec when the concentration of implanted ions is about 1×10¹⁵/cm².

As described above, the use of the low-temperature SPM effectively reduces or avoids the occurrence of the readhering residue. When, however, the low-temperature SPM is used in single-wafer SPM washing, it takes a considerably long time to remove the resist pattern. In other words, the use of the high-temperature SPM is more preferable in terms of productivity and cost.

Embodiments based on the above description will be described hereinafter.

### First Embodiment

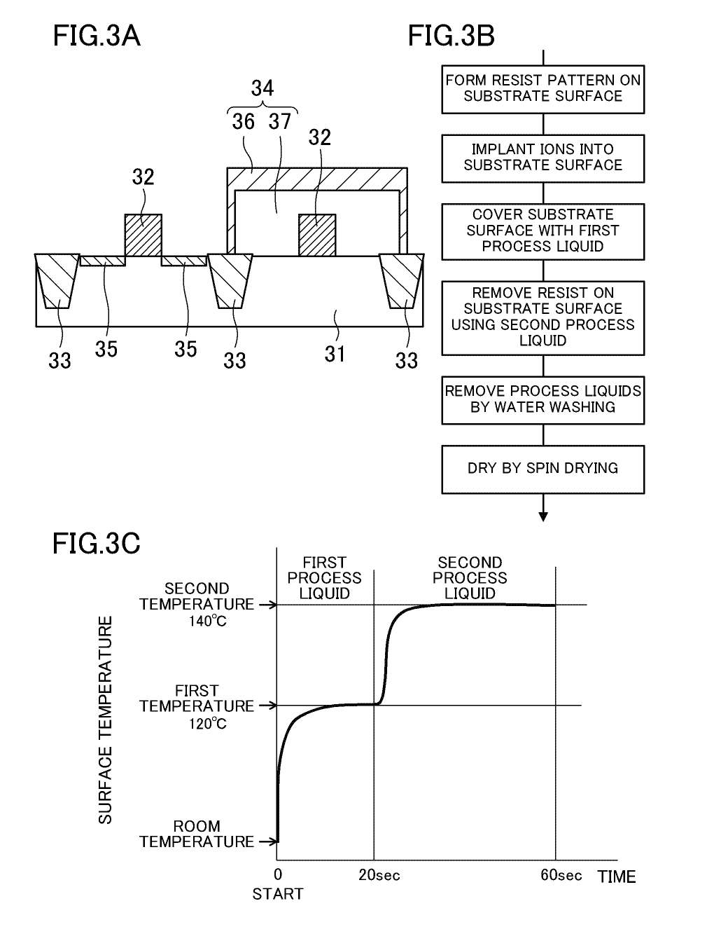

An example substrate washing method according to a first embodiment will be described hereinafter. FIG. 3A is a cross-sectional view schematically showing a structure formed on a surface of a substrate which is to be washed in this embodiment. FIG. 3B is a diagram showing an example flow of washing. FIG. 3C is a diagram showing the relationship between process times required for resist removal and temperatures of the substrate.

More specifically, FIG. 3A shows a state of a CMOS transistor with design rules of 45 nm after ion implantation as an extension region formation step. Gate electrodes 32 are formed on the substrate 31 with a gate insulating film (not shown) being interposed therebetween. Isolation regions 33 for separating active regions are formed in the substrate 31. A resist pattern 34 for separating an implantation region from a non-implantation region is formed in a predetermined region.

An extension region is formed by ion implantation using, for example, As ions at a dose of 5×10¹⁴/cm². As a result, active regions 35 in which the ions are implanted are formed in a portion of the surface of the substrate 31 which is not covered with the resist pattern 34. In this case, an altered layer 36 is formed in a surface portion of the resist pattern 34 by damage caused by the ion implantation. An unaltered resist layer 37 remains farther inside than the altered layer 36.

After the ion implantation, washing for removing the resist pattern 34 is performed. To do so, initially, a first process liquid of a first temperature is poured onto the substrate 31. Specifically, the first process liquid is an SPM which is a mixture of sulfuric acid (concentration: 95% or more) and hydrogen peroxide (concentration: 31%) at a volume ratio of 2:1. The first temperature is, for example, 120° C. The SPM is poured at a discharge flow rate of 900 ml/min while the substrate 31 is rotated at 300 rpm.

As shown in FIG. 3C, when 20 sec has elapsed since the beginning of pouring of the first process liquid onto the substrate 31, the surface of the substrate 31 is covered with the first process liquid, and the temperature of the substrate surface reaches about 120° C.

In the step of supplying the first process liquid, the resist pattern 34 may be dissolved to some extent, and the instantaneous lift-off of the altered layer 36 does not substantially occur. Because the substrate 31 is covered with the first process liquid, a stable flow of the first process liquid from the pouring position in the vicinity of the center of the substrate 31 to the edge is formed.

In such a state, a second process liquid is poured onto the substrate 31, where the second process liquid has a second temperature of, for example, 140° C. at the substrate surface. The second process liquid is an SPM having the same components as those of the first process liquid and having a different temperature. The second process liquid is similarly poured at a discharge flow rate of 900 ml/min while the substrate 31 is rotated at 300 rpm. Because the second process liquid is supplied while the surface of the substrate 31 is covered with the first process liquid, a stable flow of the process liquid on the surface of the substrate 31 is formed until the end of the process.

The second process liquid is supplied until the resist pattern 34 is completely removed from the substrate 31, e.g., for 40 sec. In this case, the temperature of the substrate surface reaches about 140° C., which is the same as the temperature of the second process liquid.

As a result, the removal of the resist pattern 34 proceeds. In this case, although the altered layer 36 is lifted off, the lifted-off altered layer is removed without readhering to the substrate 31, because of the stable flow of the process liquid on the substrate 31 from the vicinity of the center to the edge.

Thereafter, the second process liquid is removed by water washing. For example, deionized water is poured at a discharge flow rate of 2,000 ml/min while the substrate 31 is rotated at 1,000 rpm, thereby removing the second process liquid from the substrate 31. Thereafter, the substrate 31 is dried by, for example, spin drying at 2,500 rpm for 30 sec.

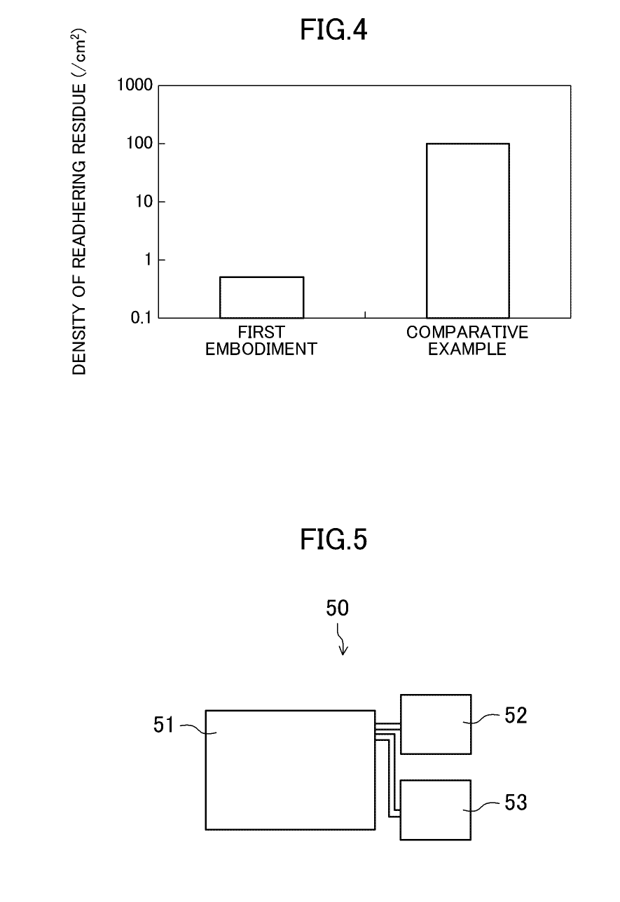

FIG. 4 shows residue densities which are obtained by the aforementioned substrate washing method of this embodiment and a comparative example washing method using the SPM of 140° C. In the comparative example washing method, a readhering residue of the resist altered layer is left at a density of about 100/cm². In the washing method of this embodiment, the residue density is reduced to about 0.5/cm².

In this embodiment, in order to remove the resist pattern 34, the first and second process liquids may be supplied for a total of about 60 sec. This period of time is much shorter than about 4,000 sec, which is required when only the process liquid of about 120° C. is used.

As described above, by using the substrate washing method of this embodiment, the occurrence of the residue can be reduced or prevented, and the increase of the process time can be reduced or prevented.

Although the first process liquid is the same as the second process liquid in this embodiment, the present disclosure is not limited to this. For example, the first process liquid may be a dilution of the second process liquid. Alternatively, a chemical liquid different from the second process liquid may be used as the first process liquid if the chemical liquid is not instantaneously evaporated by the second process liquid. For example, the first process liquid may be sulfuric acid having a liquid temperature of 80° C., and the second process liquid may be the SPM having a liquid temperature of 140° C.

When the first and second process liquids have the same composition, the first temperature may be gradually increased to the second temperature.

In order to cover the surface of the substrate 31 with the first process liquid, the first process liquid is preferably poured while the substrate 31 is rotated at a rotational speed of, for example, about 30 rpm to about 1,000 rpm. In this case, the discharge flow rate of the first process liquid is preferably within the range of about 100 ml/min or more and about 2,000 ml/min or less. Note that, even when the discharge flow rate of the first process liquid deviates from that range, the substrate 31 can be covered with the first process liquid.

A period of time for which the first process liquid is poured depends on the rotational speed of the substrate 31 and the discharge flow rate of the first process liquid. For example, when the rotational speed is 300 rpm and the discharge flow rate is 900 ml/min, the pouring time is preferably about 20 sec.

Although the first temperature is 120° C. in this embodiment, the present disclosure is not limited to this. The first temperature may be any temperature at which the altered layer is less likely to be lifted off, e.g., the range of 80° C. or more and 120° C. or less. Note that, if the first temperature is 120° C., which is a high temperature within the range, it is advantageous that the dissolution of the resist pattern 34 proceeds to some extent before the supply of the second process liquid, and therefore, the overall time that it takes to remove the resist is reduced. Although the surface temperature of the substrate 31 reaches 120° C., which is the same temperature as that of the process liquid, in this embodiment, it is not essential that the substrate 31 reaches the same temperature as that of the chemical liquid, if the surface of the substrate 31 is completely covered with the first process liquid.

The second temperature may be any temperature that is higher than that of the first temperature and at which the resist pattern 34 formed by ion implantation can be dissolved quickly (e.g., in 60 sec or less). When the SPM is used as the second process liquid for the resist containing ions which have been implanted at a dose of 5×10¹⁴/cm² or more, the second temperature is preferably 140° C. or more. As the second temperature increases, the resist can be more quickly removed. In view of the apparatus configuration etc., however, the upper limit of the second temperature is set to a temperature at which the process can be safely performed. Therefore, the second temperature is within the range of, for example, 140° C. or more and 200° C. or less. Although, in this embodiment, the surface temperature of the substrate 31 reaches 140° C., which is the same temperature as that of the process liquid, in the process in which the second process liquid is supplied, it is not essential that the temperature of the substrate 31 reaches the same temperature as that of the chemical liquid, if the resist pattern 34 is completely removed.

Although, in this embodiment, the present disclosure is applied to the extension region formation step for a CMOS transistor with design rules of 45 nm, the present disclosure is, of course, not limited to this. The present disclosure may be applied to other steps, such as a source/drain region formation step. Also, the present disclosure may be applied to transistors with design rules of less than 45 nm, or alternatively, devices other than transistors, such as image sensors (specifically, resist stripping, etc.).

### Second Embodiment

A method and apparatus for washing a substrate according to a second embodiment will be described hereinafter.

FIG. 5 is a diagram showing a configuration of an example substrate washing apparatus 50 of this embodiment. The substrate washing apparatus 50 includes a washing process chamber 51 in which a substrate is washed, a container 52 which keeps sulfuric acid which is to be supplied to the substrate, and a container 53 which keeps hydrogen peroxide which is to be supplied to the substrate.

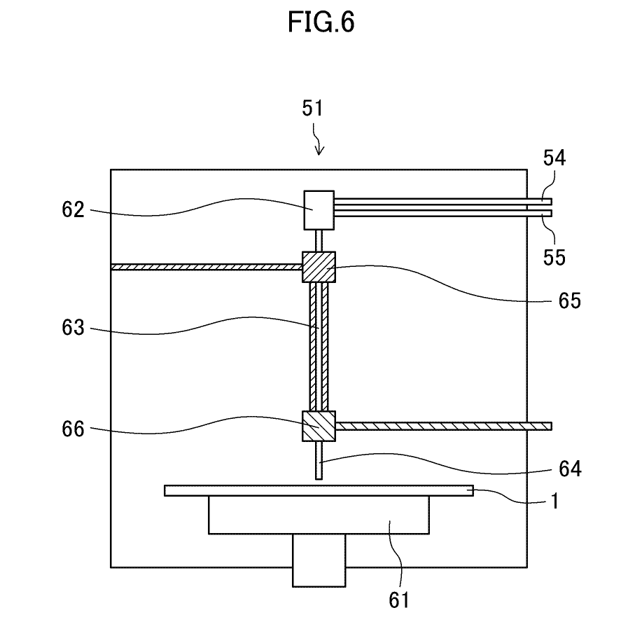

FIG. 6 schematically shows a configuration of the washing process chamber 51. The washing process chamber 51 includes a substrate holder 61 which horizontally holds a substrate 1. The washing process chamber 51 also includes a sulfuric acid pipe 54 and a hydrogen peroxide pipe 55 through which sulfuric acid and hydrogen peroxide are supplied from the containers 52 and 53 of FIG. 5, respectively, a chemical liquid mixer 62 which mixes the supplied sulfuric acid and hydrogen peroxide, a chemical liquid pipe 63 through which the chemical liquid mixture flows, and a pouring nozzle 64 from which the chemical liquid mixture is poured onto the substrate 1. The washing process chamber 51 also includes a cooling liquid-filled pipe 65 which is filled with a cooling liquid, which surrounds the chemical liquid pipe 63, and a discharge nozzle 66 from which the cooling liquid is discharged.

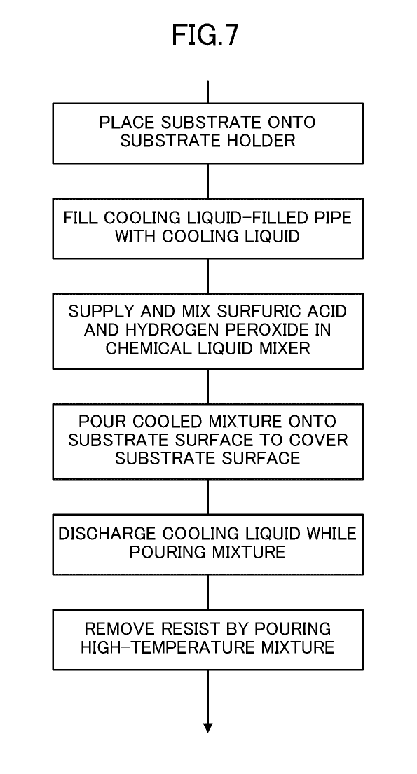

Next, FIG. 7 shows an example flow of washing the substrate using the substrate washing apparatus 50. This will be described hereinafter.

Initially, the substrate 1 is placed onto the substrate holder 61 in the washing process chamber 51.

Next, the cooling liquid-filled pipe 65 is filled with the cooling liquid. The cooling liquid-filled pipe 65 has, for example, a diameter of 10 mm and a length of 2,000 mm. The entire pipe 65 is filled with, for example, deionized water of 23° C.

Next, sulfuric acid and hydrogen peroxide are supplied from the containers 52 and 53 through the sulfuric acid pipe 54 and the hydrogen peroxide pipe 55, respectively, to the chemical liquid mixer 62, and then mixed. In this case, for example, when sulfuric acid heated to 80° C. and hydrogen peroxide of room temperature are mixed at a volume ratio of 2:1, heat is generated, so that a chemical liquid mixture (SPM) having a high temperature of about 140° C. can be obtained.

Next, the SPM flows through the chemical liquid pipe 63 and is then poured from the pouring nozzle 64 onto the substrate 1. In this case, because the cooling liquid-filled pipe 65 is filled with the cooling liquid, the SPM is cooled through the chemical liquid pipe 63 so that the temperature of the SPM is decreased to a first temperature (e.g., about 120° C.) before being poured as a first process liquid having a constant temperature onto the substrate 1.

When 20 sec has elapsed since the beginning of the pouring of the SPM of the first temperature, a surface of the substrate 1 is covered with the SPM of 120° C. Thereafter, the cooling liquid of the cooling liquid-filled pipe 65 is discharged from the discharge nozzle 66 while the SPM continues to be poured. As a result, the SPM of about 140° C. obtained by the chemical liquid mixer 62 is poured onto the substrate 1 without being cooled. Thus, the resist removal can be performed at a second temperature (e.g., about 140° C.) higher than the first temperature. Note that the pouring time of the SPM of the first temperature, the discharging of the cooling liquid, etc. are controlled by a controller (not shown) in accordance with a predetermined flow.

As described above, the substrate washing method is performed using the substrate washing apparatus 50 so that the resist can be quickly removed while reducing or preventing the occurrence of a readhering residue of the resist altered layer.

Although deionized water of 23° C. is used as the cooling liquid in this embodiment, the present disclosure is not limited to this. In order to prevent the cooling liquid from boiling in the cooling liquid-filled pipe 65 by being heated by the high-temperature SPM in the chemical liquid pipe 63, a liquid, such as hydrogen peroxide, which has a higher boiling point than that of deionized water may be used. Also, in order to prevent the cooling effect of the cooling liquid from decreasing due to an increase in the temperature, the loading of the cooling liquid into the cooling liquid-filled pipe 65 and the discharge of the cooling liquid from the discharge nozzle 66 may be continuously performed so that the cooling liquid-filled pipe 65 is invariably filled with a cooling liquid having a desired temperature. The temperature of the cooling liquid itself may be set to any arbitrary value by a temperature adjusting mechanism separately provided. The pipe length of the cooling liquid-filled pipe 65, the amount of the cooling liquid with which the cooling liquid-filled pipe 65 is filled, etc. may be set as required.

### Third Embodiment

A method and apparatus for washing a substrate according to a third embodiment will be described hereinafter.

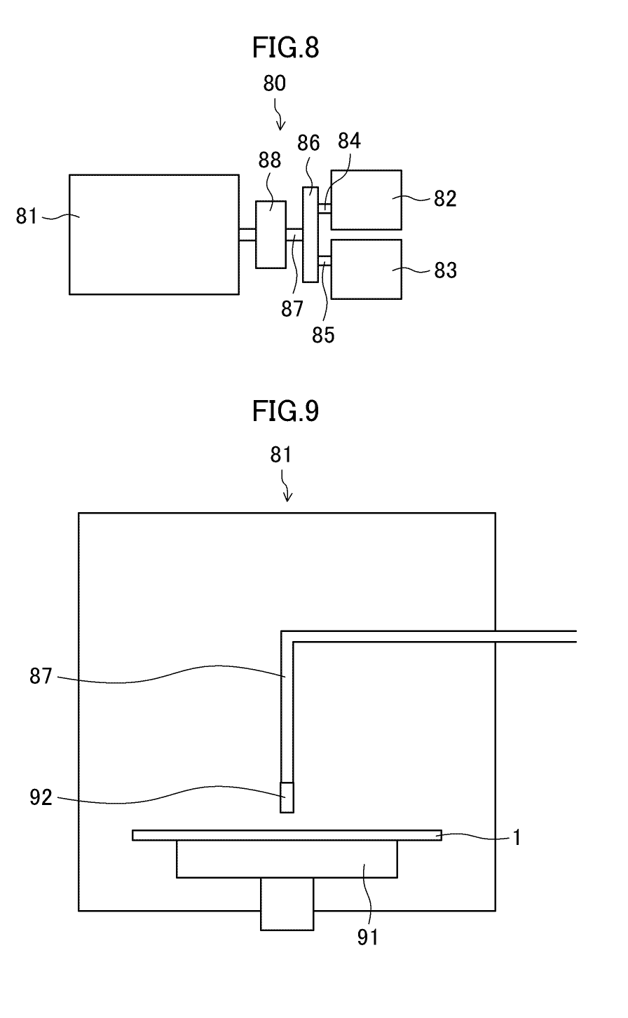

FIG. 8 is a diagram showing a configuration of an example substrate washing apparatus 80 according to this embodiment. The substrate washing apparatus 80 includes a washing process chamber 81 in which a substrate is washed, a container 82 which keeps sulfuric acid which is to be supplied to the substrate, and a container 83 which keeps hydrogen peroxide which is to be supplied to the substrate. Sulfuric acid and hydrogen peroxide are supplied from the containers 82 and 83 through a sulfuric acid pipe 84 and a hydrogen peroxide pipe 85, respectively, to a chemical liquid mixer 86, and then mixed. Thereafter, the resultant mixture is supplied through a chemical liquid pipe 87 to a mixture cooling mechanism 88. The mixture which has been cooled to a predetermined temperature by the mixture cooling mechanism 88 is supplied to the washing process chamber 81.

Next, FIG. 9 schematically shows a configuration of the washing process chamber 81. The washing process chamber 81 includes a substrate holder 91 which horizontally holds the substrate 1. The washing process chamber 81 also includes the chemical liquid pipe 87 to which the mixture is supplied from the mixture cooling mechanism 88 of FIG. 8, and a pouring nozzle 92 from which the chemical liquid mixture is poured onto the substrate 1.

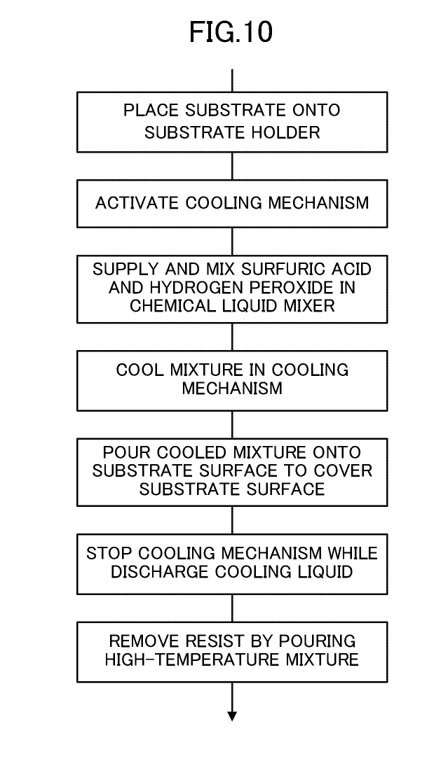

FIG. 10 shows an example flow of washing the substrate using the substrate washing apparatus 80. This will be described hereinafter.

Initially, the substrate 1 is placed onto the substrate holder 91 in the washing process chamber 81.

Next, the mixture cooling mechanism 88 is activated. Next, sulfuric acid and hydrogen peroxide are supplied from the containers 82 and 83 through the sulfuric acid pipe 84 and the hydrogen peroxide pipe 85, respectively, to the chemical liquid mixer 86, and then mixed. In this case, for example, when sulfuric acid heated to 80° C. and hydrogen peroxide of room temperature are mixed at a volume ratio of 2:1, heat is generated, so that a chemical liquid mixture (SPM) having a high temperature of about 140° C. can be obtained.

Next, the SPM is cooled to a low temperature of about 120° C. (first temperature) by the mixture cooling mechanism 88. The mixture cooling mechanism 88 may be a water- or air-cooling mechanism. After being cooled, the SPM of the first temperature flows through the chemical liquid pipe 87 and is then poured from the pouring nozzle 92 onto the substrate 1.

When 20 sec has elapsed since the beginning of the pouring of the SPM of the first temperature, a surface of the substrate 1 is covered with the SPM of 120° C. Thereafter, while the SPM continues to be poured, the cooling function of the mixture cooling mechanism 88 is stopped. As a result, the SPM of about 140° C. obtained by the chemical liquid mixer 86 is poured onto the substrate 1 without being cooled. Thus, the resist removal can be performed at a second temperature (e.g., about 140° C.) higher than the first temperature. Note that the pouring time of the SPM of the first temperature, the activating and stopping of the mixture cooling mechanism 88, etc. are controlled by a controller (not shown) in accordance with a predetermined flow.

As described above, the substrate washing method is performed using the substrate washing apparatus 80 so that the resist can be quickly removed while reducing or preventing the occurrence of a readhering residue of the resist altered layer.

### Fourth Embodiment

A method and apparatus for washing a substrate according to a fourth embodiment will be described hereinafter.

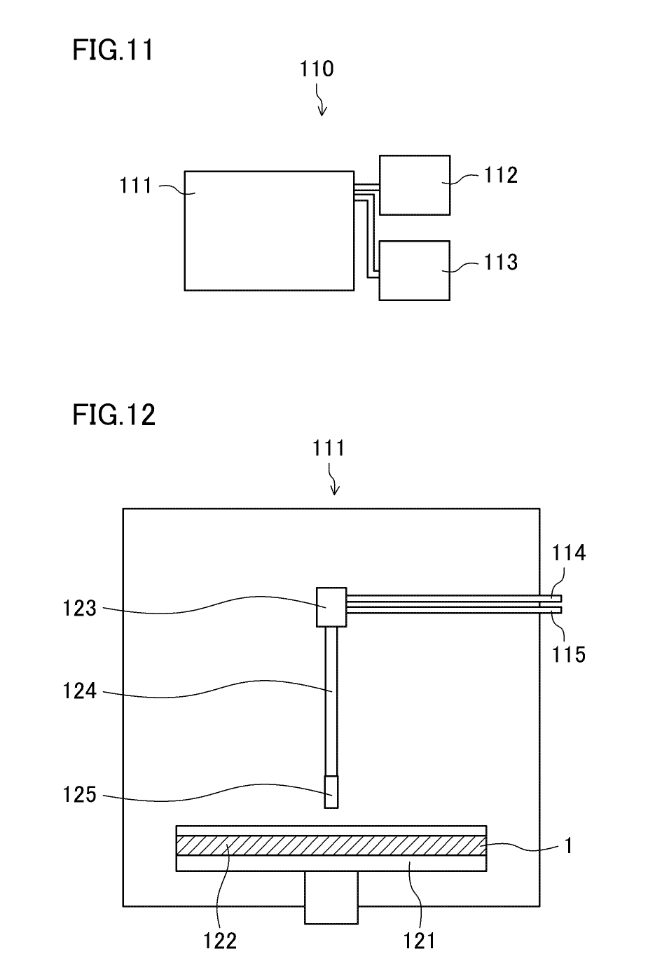

FIG. 11 is a diagram showing a configuration of an example substrate washing apparatus 110 according to this embodiment. The substrate washing apparatus 110 includes a washing process chamber 111 in which a substrate is washed, a container 112 which keeps sulfuric acid which is to be supplied to the substrate, and a container 113 which keeps hydrogen peroxide which is to be supplied to the substrate.

FIG. 12 schematically shows a configuration of the washing process chamber 111. The washing process chamber 111 includes a substrate holder 121 which horizontally holds the substrate 1. The substrate holder 121 includes a temperature adjusting mechanism 122. The washing process chamber 111 also includes a sulfuric acid pipe 114 and a hydrogen peroxide pipe 115 through which sulfuric acid and hydrogen peroxide are supplied from the containers 112 and 113 of FIG. 11, respectively, a chemical liquid mixer 123 which mixes the supplied sulfuric acid and hydrogen peroxide, a chemical liquid pipe 124 through which the chemical liquid mixture flows, and a pouring nozzle 125 from which the chemical liquid mixture is poured onto the substrate 1.

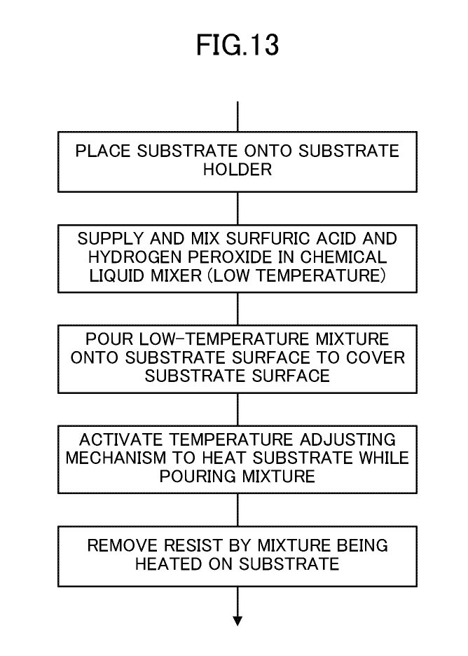

FIG. 13 shows an example flow of washing the substrate using the substrate washing apparatus 110. This will be described hereinafter.

Initially, the substrate 1 is placed onto the substrate holder 121 in the washing process chamber 111.

Next, sulfuric acid and hydrogen peroxide are supplied from the containers 112 and 113 through the sulfuric acid pipe 114 and the hydrogen peroxide pipe 115, respectively, to the chemical liquid mixer 123, and then mixed. In this case, for example, sulfuric acid heated to 40° C. and hydrogen peroxide of room temperature are mixed at a volume ratio of 2:1, to obtain an SPM having a relatively low temperature of about 120° C. or less.

Next, the SPM flows through the chemical liquid pipe 124 and is then poured from the pouring nozzle 125 onto the substrate 1. In this case, the SPM having a low temperature (first temperature, e.g., about 120° C.) is supplied onto a surface of the substrate 1.

When 20 sec has elapsed since the beginning of the pouring of the SPM of the first temperature, a surface of the substrate 1 is covered with the SPM of 120° C. Thereafter, the temperature adjusting mechanism 122 is activated to adjust the surface temperature of the substrate 1 to a higher temperature (second temperature, e.g., 140° C. or more) than the first temperature. As a result, the SPM is heated on the substrate 1, so that the SPM having a high temperature (e.g., 140° C. or more) covers the surface of the substrate 1. Thus, the SPM having the second temperature (e.g., 140° C. or more) higher than the first temperature can be used to remove the resist. The pouring time of the SPM, the activation of the temperature adjusting mechanism 122, etc. are controlled by a controller (not shown) in accordance with a predetermined flow.

As described above, the substrate washing method is performed using the substrate washing apparatus 110 so that the resist can be quickly removed while reducing or preventing the occurrence of a readhering residue of the resist altered layer.

Note that the apparatuses of the second to fourth embodiments may be used singly or in combination.

As described above, the substrate washing method and the substrate washing apparatus of the present disclosure can cleanly and quickly remove an ion-implanted resist from a substrate, and therefore, are useful for manufacture of semiconductor devices.

What is claimed is:

1. A substrate washing method comprising the steps of:
(a) supplying a first process liquid of a first temperature onto a substrate having a resist pattern, to cover a surface of the substrate with the first process liquid; and
(b) supplying a second process liquid onto the surface of the substrate covered with the first process liquid, to cover the surface of the substrate with the second process liquid of a second temperature higher than the first temperature, thereby removing the resist pattern.

2. The substrate washing method of claim 1, wherein
in step (b), the surface temperature of the substrate reaches the second temperature.

3. The substrate washing method of claim 1, wherein
in step (b), the second process liquid of the higher temperature than that of the first process liquid is supplied to the surface of the substrate.

4. The substrate washing method of claim 1, wherein
in step (b), by heating the substrate, the temperature of the second process liquid is increased to the second temperature.

5. The substrate washing method of claim 1, wherein
the resist pattern contains implanted ions.

6. The substrate washing method of claim 5, wherein
an altered layer is formed in a surface of the resist pattern by ion implantation.

7. The substrate washing method of claim 6, wherein
the altered layer is formed by implanting ions into the resist pattern at a dose of 5×10¹⁴/cm² or more.

8. The substrate washing method of claim 6, wherein
the first temperature is a temperature at which the altered layer is not lifted off.

9. The substrate washing method of claim 1, wherein
the second process liquid is a mixture of sulfuric acid and hydrogen peroxide.

10. The substrate washing method of claim 1, wherein
the first temperature is 80° C. or more and 120° C. or less,
the second temperature is 140° C. or more and 200° C. or less, and
the first and second process liquids are each a mixture of sulfuric acid and hydrogen peroxide.

11. A substrate washing apparatus comprising:
a substrate holder configured to hold a substrate;
a chemical liquid mixer configured to mix a first chemical liquid and a second chemical liquid to obtain a third chemical liquid;
a pouring nozzle configured to pour the third chemical liquid onto the substrate;
a chemical liquid pipe configured to allow the third chemical liquid to flow from the chemical liquid mixer to the pouring nozzle; and
a cooling liquid-filled pipe configured to cover the chemical liquid pipe.

12. The substrate washing apparatus of claim 11, wherein
the third chemical liquid, when flowing through the chemical liquid pipe, is cooled by a cooling liquid with which the cooling liquid-filled pipe is filled.

13. A substrate washing apparatus comprising:
a substrate holder configured to hold a substrate;
a chemical liquid mixer configured to mix a first chemical liquid and a second chemical liquid to obtain a third chemical liquid;
a chemical liquid temperature adjuster configured to adjust the temperature of the third chemical liquid; and
a pouring nozzle configured to pour the third chemical liquid onto the substrate.

14. A substrate washing apparatus comprising:
a substrate holder configured to hold a substrate;
a chemical liquid mixer configured to mix a first chemical liquid and a second chemical liquid to obtain a third chemical liquid;
a pouring nozzle configured to pour the third chemical liquid onto the substrate; and
a substrate temperature adjuster configured to adjust the temperature of the substrate.

15. The substrate washing apparatus of claim 11, wherein
the mixing of the first and second chemical liquids generates heat.

16. The substrate washing apparatus of claim 13, wherein
the mixing of the first and second chemical liquids generates heat.

17. The substrate washing apparatus of claim 14, wherein
the mixing of the first and second chemical liquids generates heat.
